(19) United States
(12) Patent Application Publication
(10) Pub. No.: US 2026/0006077 A1
(43) Pub. Date: Jan. 1, 2026

(54) System, Apparatus, and Method to Generate Decoy Honeypots by Using Generated Adversarial Networks

(71) Applicant: The United States of America as represented by the Secretary of the Navy, Arlington, VA (US)

(72) Inventors: Mark Bilinski, Vista, CA (US); Ryan Christopher Gabrys, San Diego, CA (US); Daniel Silva, El Cajon, CA (US); Braulio Ivan Coronado, San Diego, CA (US)

(73) Assignee: The United States of America as represented by the Secretary of the Navy, Arlington, VA (US)

(21) Appl. No.: 18/978,962

(22) Filed: Dec. 12, 2024

Related U.S. Application Data
(60) Provisional application No. 63/665,819, filed on Jun. 28, 2024.

(51) Int. Cl. H04L 9/40

(52) U.S. Cl. CPC H04L 63/1491

(57) ABSTRACT

A system, apparatus, and method to generate decoy honeypots by using generated adversarial networks. In some embodiments, a method for generating decoy honeypots, the steps comprising identifying a plurality of network device configurations on a network; instantiating a generative adversarial network comprising architecture properties; generating a plurality of decoy honeypots with the generative adversarial network, wherein the plurality of decoy honeypots imitate the plurality of network device configurations to deceive malicious actors, and wherein the generative adversarial network optimizes a distribution of the plurality of decoy honeypots according to a precision distribution and a recall distribution; activating the plurality of decoy honeypots to the network; and dynamically evolving the plurality of decoy honeypots towards one or more preferences of a network attacker.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: niwc_patent.fct@us.navy.mil, referencing Navy Case 211,727.

### FIELD OF USE

The present disclosure pertains generally to cyber-security defense techniques including generating decoy honeypots with generative adversarial networks that include, but are not limited to, imitating network device configurations.

### BACKGROUND

The field of cybersecurity constantly faces the challenge of defending networks and systems against malicious attacks. One effective approach to deceive adversaries and gather intelligence about their tactics is through the use of decoy systems, which are commonly known as decoys or decoy honeypots. By strategically deploying decoy honeypots at different stages of the cyber kill chain, organizations can gain valuable insights into the attacker's methods, motives, and vulnerabilities. Honeypots can provide early warning signs, capture attack tools or malware samples, and gather valuable threat intelligence that can enhance overall security.

### Generative Adversarial Networks

Generative adversarial networks (GANs) have gained significant attention due to their ability to generate synthetic data simulating realistic media such as images, text, audio and videos. Unlike traditional generative models which are typically trained by maximizing a log likelihood, GANs possess a unique architectural setup comprising two neural networks: the generator and the discriminator.

The generator network takes random noise as input and generates synthetic samples, such as images, text, or even audio. The discriminator network, on the other hand, receives both real and generated samples and tries to distinguish be-tween them. The two networks are trained together in a competitive setting, constantly improving and challenging each other's performance. More specifically, the discriminator, denoted here as D, and generator, denoted here as G, play the following two-player min-max game with value function in Eq. 1-V (G, D):

$${min}_{G} {max}_{D} V ( D , G ) = {E}_{x ∼ {p}_{r} ( x )} [ log D ( x ) ] + {E}_{z ∼ {p}_{g} ( z )} [ log ( 1 - D ( G ( Z ) ) ) ] \qquad ( Eq . 1 )$$

In Eq. 1, p_{g} represents the generator's distribution and p_{z} represents a prior on input noise variables. The generator aims to generate samples that are indistinguishable from real data, while the discriminator strives to correctly classify between real and fake samples. As training progresses, the generator learns to produce increasingly realistic samples by receiving feedback from the discriminator. The discriminator, in turn, becomes more adept at distinguishing between real and generated data.

The applications of GANs span a wide range of domains. In computer vision, GANs have been used for image synthesis, style transfer, image-to-image translation, and super-resolution. They have also been employed in generating realistic deep fake videos and enhancing image generation in areas like fashion, art, and design. In natural language processing, GANs have been utilized for text generation, language translation, and dialogue systems. GANs have even found applications in healthcare, where they have been used for generating synthetic medical images, augmenting data for training medical models, and drug discovery. Nowadays, GANs are broadly studied and applied through academic and industrial research in different domains beyond media (e.g., natural language processing, medicine, electronics, networking, and cybersecurity). After a GAN has been trained, its generator can produce as many synthetic examples as necessary, providing an efficient mechanism for solving the problem of lack of labelled data sets and potential privacy restrictions.

### Cyber Defensive Deception

Honeypots are decoy systems or resources intentionally designed to attract and deceive malicious actors, allowing cybersecurity professionals to study their behavior, gather intelligence, and enhance their defensive strategies. One of the many advantages of employing honeypots in network environments is that they can provide insights into attacker tactics, helping organization improve their defense mechanisms against such threats.

### SUMMARY

According to illustrative embodiments, a method for generating decoy honeypots, the steps comprising identifying a plurality of network device configurations on a network; instantiating a generative adversarial network comprising architecture properties; generating a plurality of decoy honeypots with the generative adversarial network, wherein the plurality of decoy honeypots imitate the plurality of network device configurations to deceive malicious actors, and wherein the generative adversarial network optimizes a distribution of the plurality of decoy honeypots according to a precision distribution and a recall distribution; activating the plurality of decoy honeypots to the network; and dynamically evolving the plurality of decoy honeypots towards one or more preferences of a network attacker.

In some embodiments, a non-transitory computer-readable storage medium comprising computer readable instructions for generating decoy honeypots by using generative adversarial networks, the instructions performing operations comprising: identifying a plurality of network device configurations on a network; instantiating a generative adversarial network comprising architecture properties; generating a plurality of decoy honeypots with the generative adversarial network, wherein the plurality of decoy honeypots imitate the plurality of network device configurations to deceive malicious actors, and wherein the generative adversarial network optimizes a distribution of the plurality of decoy honeypots according to a precision metric and a recall metric; activating the plurality of decoy honeypots to the network; and dynamically evolving the plurality of decoy honeypots towards one or more preferences of a network attacker.

In some embodiments a network decoy server, comprising: a network interface communicatively coupled to a network; at least one processor coupled to the network interface; at least one memory coupled to the at least one processor, the at least one memory have instructions stored there, which when executed by the at least one process, direct the network decoy server to: identifying a plurality of network device configurations on a network; instantiating a generative adversarial network comprising architecture properties; generating a plurality of decoy honeypots with the generative adversarial network, wherein the plurality of decoy honeypots imitate the plurality of network device configurations to deceive malicious actors, and wherein the generative adversarial network optimizes a distribution of the plurality of decoy honeypots according to a precision metric and a recall metric; activating the plurality of decoy honeypots to the network; and dynamically evolving the plurality of decoy honeypots towards one or more preferences of a network attacker.

It is an object to provide a System, Apparatus, and Method to Generate Decoy Honeypots by Using Generated Adversarial Networks that offers numerous benefits, including providing a lightweight GAN that can generate honeypot decoys based on current network configurations and dynamically updated the decoy configurations to prevent cyberattacks.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1 illustrates an exemplary malicious actor causing a cybersecurity threat a network.

FIG. 2 shows a block diagram illustration of one embodiment of a network server.

FIG. 3 shows a block diagram illustration of one embodiment of a generative adversarial network (“GAN”).

FIG. 4 shows a block diagram illustration of a method for generating decoy honeypots.

FIG. 5A shows a block-diagram illustration of one embodiment of a discriminator model comprising fractionally strided convolutions.

FIG. 5B shows a block-diagram illustration of one embodiment of a generator model for performing a deconvolution procedure.

FIG. 6A shows an exemplary JSON document illustrating a device configuration for a Windows Server running three services.

FIG. 6B shows an exemplary data model for Machine Configuration.

FIG. 7A shows a graph of a recall metric versus a precision metric for an exemplary unconditionally trained GAN for decoy honeypots.

FIG. 7B shows a graph of a recall metric versus a precision metric for an exemplary conditionally trained GAN for decoy honeypots, wherein the conditional training comprises specifying an operating system.

FIG. 7C shows a graph of a recall metric versus a precision distribution for an exemplary conditionally trained GAN for decoy honeypots, wherein the conditional training comprises specifying a device type.

FIG. 8A shows a table comprising exemplary generator output as a function of sample size for an unconditional GAN.

FIG. 8B shows a table comprising an operating system and label count, for this embodiment, displaying the number of configurations in our dataset for each of the possible types of operating systems.

FIG. 8C shows a table comprising device types, substrings, and counts.

FIG. 9A shows showing the fraction of unique samples that were generated by one embodiment of each of GAN as a function of the number of total samples requested.

FIG. 9B shows the fraction of generated samples that match real samples.

### DETAILED DESCRIPTION

The disclosed apparatus, system, and method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other apparatus, system, and methods described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

There has been a long multi decade arms race between cyber defenders and attackers. Honeypots are a tool used by defenders, which try to lure attackers to interact with them and thereby alert the defender, learn something about the attacker, trap/waste time of attacker-generally bad for the attacker. Attackers conversely develop tools and techniques to detect and thereby avoid interacting with those honeypots. This disclosed subject matter presents techniques, systems, and methods providing many benefits, including using Generated Adversarial Networks (GANs) to further enhance honeypots and make them less detectable. As used herein, a generative adversarial network may generate decoys by identifying current network configurations and then dynamically generating “realistic” looking new configurations.

Honeypots are typically categorized as being either high or low-interaction depending on their level of sophistication. Low-interaction honeypots typically target an attacker at the earlier phases of the cyber kill chain, such as reconnaissance, whereas the high-interaction honeypots aim to disrupt potential attackers at later phases, such as delivery and lateral movement. This work can be applied to generate either low-interaction or high-interaction honeypots. In one embodiment, the content of this disclosure comprises is on the design and generation of realistic-looking low-interaction honeypots that can be used in the context of a cyber-defense strategy to detect, deter and/or delay potential attackers.

One embodiment of the proposed apparatus, system, and method herein comprises an adaptable infrastructure that may utilize two essential pieces of information: the services available on each open port and the operating system details. Challenges with existing approaches include determining which decoy configurations to choose from, as well as how the configurations should be generated. Some naive approaches involve maintaining a list of possible device configurations or in some cases even storing collections of pre-configured images.

The disclosed subject matter harnesses the capabilities of GANs to learn the distribution of network device configurations using real data. This approach offers remarkable flexibility, as cyber defenders no longer need to maintain collections of potential configurations. Instead, our GAN-powered system dynamically generates realistic-looking decoy configurations based on specified requirements. Particularly in scenarios where a large number of diverse and authentic-looking decoys are desired, this methodology has the potential to offer enormous benefit.

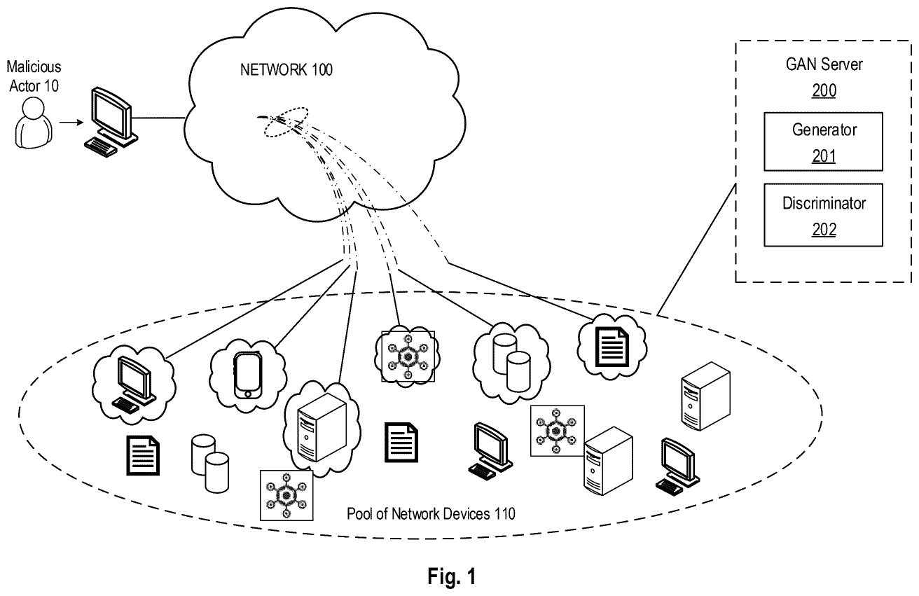

FIG. 1 illustrates an exemplary malicious actor 10 causing a cybersecurity threat a network 100 comprising a pool of network devices 110, wherein at least one of the network devices may be decoy honeypot generated at a generative adversarial network server 200. The GAN network server 200 comprises a generator 201 and a discriminator 202. As shown in FIG. 1, the pool of network device may comprise network decoys and devices. The decoys imitate the network devices and lure cyberattacks into attacking “fake” devices. The following are some embodiments of the A System, Apparatus, and Method to Generate Decoy Honeypots by Using Generated Adversarial Networks, are not so limited.

In some embodiments, a GAN may generate high-quality replicas of actual network device configurations using the concepts of precision and recall trained on a simple data model. In some embodiments, a cyber-defender may generate certain types of decoys by training a conditional GAN based on specified requirements. For examples, a conditional GANs may generate network device configurations based upon operating system or service type. These decoys created from our generative models are demonstrated to provide robust honeypot decoys. A common industry tool for the deployment and evaluation of honeypot decoys is by using HoneyD and then check them using the Checkpot (https://github.com/vladalexgit/checkpot) tool.

Moreover, a system, apparatus, or method of deploying network decoys with GANs may comprise two general functions. First, after scanning the network for existing configurations it can then be used to create replicas of existing device configurations, on demand, as honeypots flooding the network with identical decoys that make it more difficult to tell which of these identical systems is the real one. Second, it can generate novel configurations that are not easily discernable as honeypots and thus might be more likely to be considered as real systems themselves. The first application more directly defends a target of value whereas the second makes attacker accidental interaction with a honeypot more likely. A primary benefits of the approach described herein is that the configurations can continue to evolve and thus novel honeypots can leave and enter the network regularly, making it difficult for the attacker to maintain accurate knowledge of what is real vs fake.

Furthermore, another significant advantage of the contents of this disclosure is the dynamic nature of the honeypot configurations that are generated. The plurality of decoy honeypots may dynamically evolve towards one or more preferences of a network attacker. The GAN dynamically adapts by initiating a subsequent assessment of network configurations either at a certain epoch or at the request of the user, then may integrate new configurations or network conditions into subsequent decoy generation. The subsequent assessment may include the previously generated decoys, user-provided target input for GAN evolution comprising specific user-defined decoy characteristics, and changing real-world network conditions or mission priorities. By dynamically updated the decoy honeypots, new configurations being deployed may regularly change and thus increase potential for attacker confusion/mistakes.

Another improvement is that by not exactly duplicating existing configurations, these honeypots are more likely to be confused as real systems and thus be interacted with in the first place. The conditional GAN then allows the user to influence the evolution through the GAN towards specific operating systems or service types-the conditional GAN itself not being novel but rather its application to this problem is. The whole system is also designed to be relatively low level of effort on the part of the user. The system configurations can be scanned from the existing network, the GAN evolution takes place on its own-each step requiring minimal user input, and definitely not manual configuration.

Another issue is in deploying honeypots, often in addition to the configuration, an entire image is usually stored for deployment. This requires tremendous storage resources and is not scalable. Instead with this approach one don't need to store those images, we can dynamically change the configurations of an existing image.

When existing honeypots are configured, changing configurations on demand is a painful process. The disclosed subject matter can continuously be generating new configurations that are ready to go on demand or even optimized for a different service. So when a decision is made to change out honeypots or even change strategy, this approach could have already generated valid configurations to support that change.

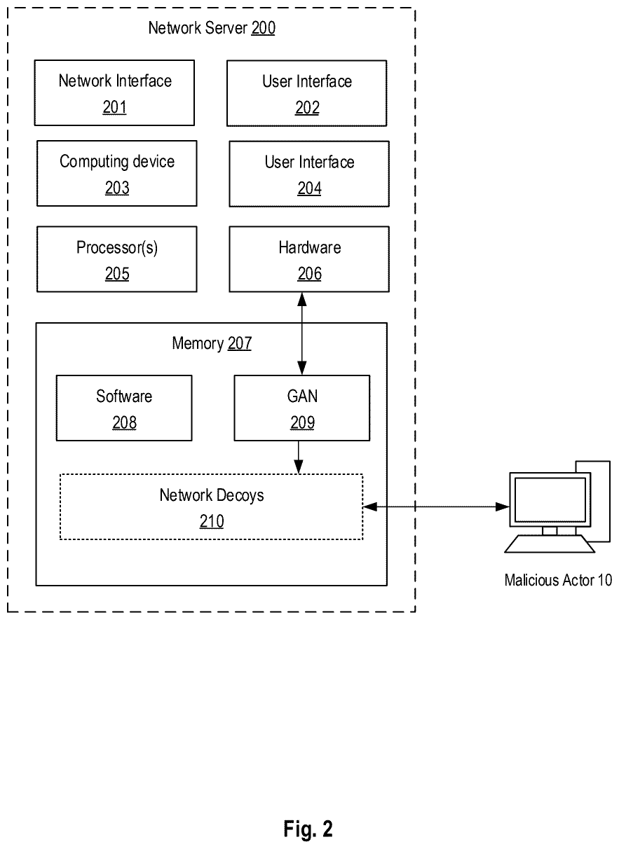

FIG. 2 shows a block diagram illustration of one embodiment of a network server 200 comprising a network interface 201, user interface 202, computing device 203, user interface 204, processor(s) 205, hardware 206, and memory 207 further comprising software 206, a generative adversarial network 209, and a plurality of network decoys 210 for deceiving a malicious actor 10.

An exemplary operating environment for implementing various aspects of this disclosure is illustrated in FIG. 2. As illustrated in FIG. 2, an exemplary operating environment 200 may include a computing device 203 (e.g., a general-purpose computing device) in the form of a computer. Components of the computing device may include, but are not limited to, various hardware components, such as one or more processors 205, data storage, a system memory 207, hardware 206, and a system bus (not shown) that couples (e.g., communicably couples, physically couples, and/or electrically couples) various system components such that the components may transmit data to and from one another, The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

With further reference to FIG. 2, an operating environment 200 for an exemplary embodiment includes at least one computing device 203. The computing device 203 may be a uniprocessor or multiprocessor computing device. An operating environment 200 may include one or more computing devices in a given computer system, which may be clustered, client-server networked, peer-to-peer networked within a cloud, or otherwise communicably linked. A computer system may include an individual machine or a group of cooperating machines, A given computing device 203 may be configured for end-users, e.g., with applications, for administrators, as a server, as a distributed processing node, as a special-purpose processing device, or otherwise configured to train machine learning models and/or use machine learning models.

Other computerized devices and/or systems not shown in FIG. 2 may interact in technological ways with computing device 203 or with another system using one or more connections to a network 210 via a network interface 201, which may include network interface equipment, such as a physical network interface controller (NIC) or a virtual network interface (VIF).

A user interface 202 may support interaction between an embodiment and one or more users. A user interface 202 may include one or more of a command line interface, a graphical user interface (GUI), natural user interface (NUI), voice command interface, and/or other user interface (UI) presentations, which may be presented as distinct options or may be integrated. A user may enter commands and information through a user interface (e.g., user interface 202) or other input devices such as a tablet, electronic digitizer, a microphone, keyboard, and/or pointing device, commonly referred to as mouse, trackball or touch pad (e.g., input/output devices). Other input devices may include a joystick, game pad, satellite dish, scanner, or the like (e.g., input/output devices). Additionally, voice inputs, gesture inputs using hands or fingers, or other NUI may also be used with the appropriate input devices (e.g., input/output devices), such as a microphone, camera, tablet, touch pad, glove, or other sensor. These and other input devices are often connected to the processing units through a user input interface that is coupled to the system bus, but may be connected by other interface and bus structures, such as a parallel port, game port or a universal serial bus (USB). A monitor or other type of display device may also be connected to the system bus via an interface, such as a video interface. The monitor may also be integrated with a touch-screen panel or the like. Note that the monitor and/or touch screen panel can be physically coupled to a housing in which the computing device (e.g., computing device 203) is incorporated, such as in a tablet-type personal computer. In addition, computers such as the computing device may also include other peripheral output devices such as speakers and printer, which may be connected through an output peripheral interface or the like.

Computing device 203 includes at least one logical processor 205. The computing device 203, like other suitable devices, also includes one or more computer-readable storage media, which may include, but are not limited to, memory 207 and data storage. In some embodiments, memory 207 and data storage may be part of a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium such as a portable (i.e., external) hard drive, compact disc (CD), Digital Versatile Disc (DVD), memory stick, or other removable non-volatile memory medium may become functionally a technological part of the computer system when inserted or otherwise installed with respect to one or more computing devices 203, making its content accessible for interaction with and use by processor(s) 205. The removable configured medium is an example of a computer-readable storage medium. Some other examples of computer-readable storage media include built-in random access memory (RAM), read-only memory (ROM), hard disks, and other memory storage devices which are not readily removable by users (e.g., memory 207).

The configured medium may be configured with instructions (e.g., binary instructions) that are executable by a processor 205; “executable” is used in a broad sense herein to include machine code, interpretable code, bytecode, compiled code, and/or any other code that is configured to run on a machine, including a physical machine or a virtualized computing instance (e.g., a virtual machine or a container). The configured medium 120 may also be configured with data which is created by, modified by, referenced by, and/or otherwise used for technical effect by execution of the instructions. The instructions and the data may configure the memory or other storage medium in which they reside.

Although an embodiment may be described as being implemented as software instructions executed by one or more processors in a computing device (e.g., general-purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processor(s) 205 (e.g., one or more CPUs, ALUs, FPUs, and/or GPUs), memory 207, data storage, and screens/displays, an operating environment 200 may also include other hardware 206, such as batteries, buses, power supplies, wired and wireless network interface cards, for instance. The nouns “screen” and “display” are used interchangeably herein. A display may include one or more touch screens, screens responsive to input from a pen or tablet, or screens which operate solely for output. In some embodiment, other input/output devices such as human user input/output devices (screen, keyboard, mouse, tablet, microphone, speaker, motion sensor, etc.) will be present in operable communication with one or more processors 205 and memory.

Memory includes computer storage media in the form of volatile and/or nonvolatile memory. The memory may be removable, non-removable, or a combination thereof. Examples of hardware devices include solid-state memory, hard drives, optical-disc drives, etc. Processors 205 read data from various entities such as memory 103 or I/O components. Memory 207 stores, among other data, one or more applications. The applications, when executed by the one or more processors, operate to perform functionality on the computing device. The applications may communicate with counterpart applications or services such as web services accessible via a network (not shown). For example, the applications may represent downloaded client-side applications that correspond to server-side services executing in a cloud. In some examples, aspects of the disclosure may distribute an application across a computing system, with server-side services executing in a cloud based on input and/or interaction received at client-side instances of the application. In other examples, application instances may be configured to communicate with data sources and other computing resources in a cloud during runtime, such as communicating with a cluster manager or health manager during a monitored upgrade or may share and/or aggregate data between client-side services and cloud services.

Furthermore, the generative and/or discriminator network may comprise or be connected to a non-transitory computer-readable medium, which includes any mechanism that provides (i.e., stores) information in a form accessible by a machine (e.g., a computer, network device, personal digital assistant, manufacturing tool, any device with a set of one or more processors, etc.). For example, a machine-readable medium may include recordable or non-recordable media (e.g., read only memory (ROM), random access memory (RAM), magnetic disk storage media, optical storage media, flash memory devices, etc.). In one embodiment, the gala architecture may export its data via two direct memory access (DMA) blocks that move data in to the central memory of a CPU.

### GAN Architecture

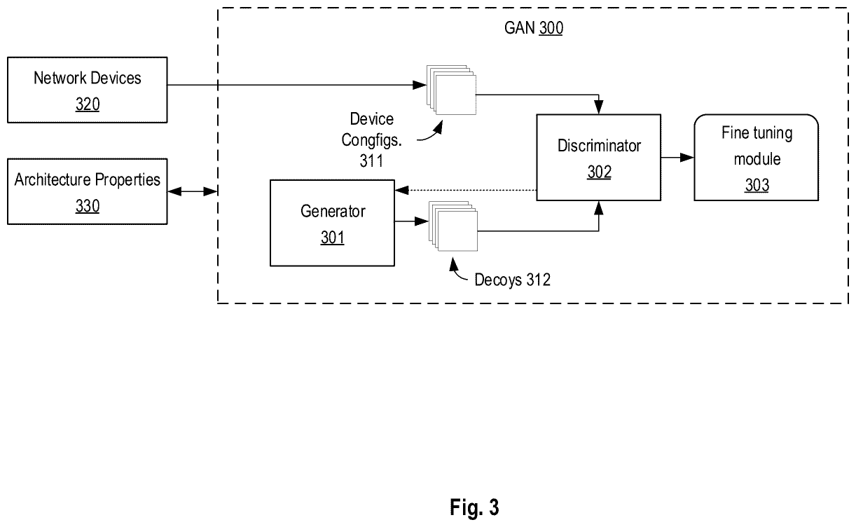

FIG. 3 shows a block diagram illustration of one embodiment of a generative adversarial network 300 comprising a generator 301 for generating decoys 311 a discriminator 302 configured to receive device configurations 311 and generated decoys 312 a fine tuning module 303, wherein the generative adversarial network may comprise architecture properties 330. The GAN 300 may receive device configurations 311 of network devices 320 to provide real examples to the discriminator 302. The generator 301 generates decoys 312 and provides them to discriminator 302, which new decoys may be generated continuously and dynamically based on feedback from the discriminator 302. The discriminator 302 assesses the decoys as true/false compared to the real device configurations in order to optimize the GAN towards realistic decoy honeypots. The discriminator 302 may further be connected to a fine tuning module 303, which may determine if the discriminator 302 is correct. In some embodiments, the fine tuning module may further comprising a discriminator loss module and a generator loss module.

In one embodiment, the GAN 300 may comprising the following one or more of the following architecture properties 330:
Batch Size: This refers to the number of machine con-figurations that are used for training at each iteration of the optimizer. In one embodiment, a batch size of 64.
Number of steps: Each step may involve a single generator iteration along with 3 discriminator training iterations. In one embodiment, an unconditional GAN may be trained for 11844 steps. In some embodiments, a conditional O/S GAN and conditional GAN may be trained for 5922 and 23688 steps, respectively.
Gradient Penalty Coefficient: This represents the loss term that keeps the L2 norm of the discriminator gradients close to 1. In one embodiment, this parameter may be set to 10.
Adam optimizer hyper parameters:
   Learning Rate: Controls how quickly parameters in the model are updated.
   Coefficient β₁, β₂: Manages the decay rates of the moving average of the gradient and the squared gradient.

For one exemplary setup, one may set the learning rate to be 0002 and the values of β₁, β₂ to be 0.5, 0.9.

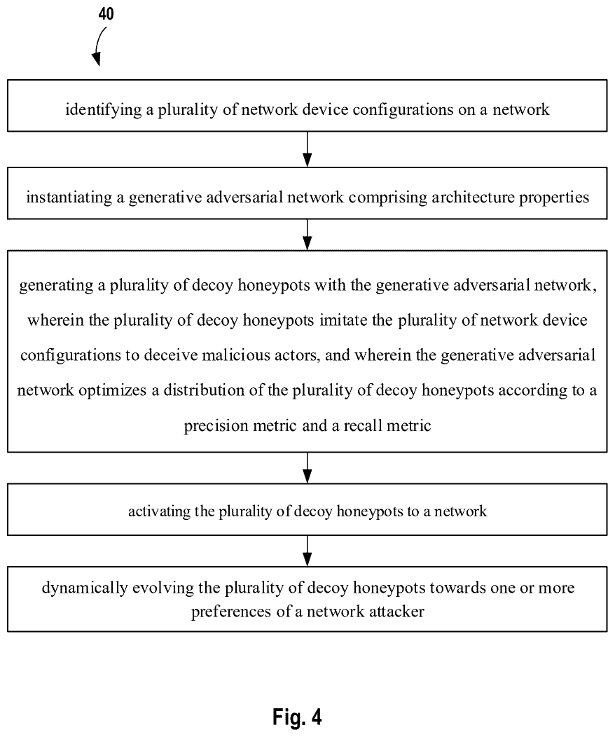

FIG. 4 shows a block diagram illustration of a method for generating decoy honeypots 40, the steps comprising: identifying a plurality of network device configurations on a network; instantiating a generative adversarial network comprising architecture properties; generating a plurality of decoy honeypots with the generative adversarial network, wherein the plurality of decoy honeypots imitate the plurality of network device configurations to deceive malicious actors, and wherein the generative adversarial network optimizes a distribution of the plurality of decoy honeypots according to a precision metric and a recall metric; activating the plurality of decoy honeypots to the network; and dynamically evolving the plurality of decoy honeypots towards one or more preferences of a network attacker.

The method for generating cybersecurity decoys may further comprise using a trained neural network to determine a precision metric of the plurality of network device configurations; using a trained neural network to determine a recall metric of the plurality of network device configurations.

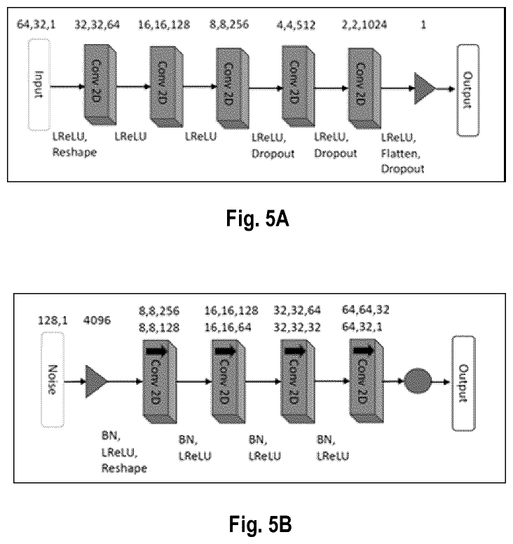

The architecture of a System, Apparatus, and Method to Generate Decoy Honeypots by Using Generated Adversarial Networks may comprise two neural networks using generative adversarial networks. Many types and architectures generative adversarial networks may be used to create decoy honeypots as described herein. Some example architectures of a GAN network are shown in FIGS. 5A and 5B, but this disclosure is not so limited.

FIG. 5A shows a block-diagram illustration of one embodiment of a discriminator model comprising fractionally strided convolutions. Each of the plurality of fractionally strided convolutions (“Conv 2D”) may comprise rectified linear unit (“ReLU”) or Leaky rectifier (“LReLU”) as described by the notation between each of the convolution blocks shown in FIG. 5A. Above each of the convolution blocks shows an object size. One embodiment of a discriminator model has a normal convolution layer followed by four convolution layers using a stride of 2 and a kernel of size 5 to downsample the input. The final layer of the discriminator may be a dense layer that provides a single output.

FIG. 5B shows a block-diagram illustration of one embodiment of a generator model for performing a deconvolution procedure. In one embodiment, the generator may comprise four blocks wherein each block performs upsampling followed by a convolution layer that has a kernel of size 3 with a stride of size 1. Above each of the blocks shows an exemplary object size. After these four blocks, the data is passed through a final activation layer.

Each of the discriminator and generator models are trained neural networks. Both the exemplary discriminator and generator models may be trained, for example, according using the Wassterstein GAN with Gradient Penalty method.

In one embodiment described for an illustrative example, the GAN described above and having the architecture shown in FIGS. 5A and 5B may be trained using a set of device configurations that were obtained using the Shodan search engine. Using Shodan, we were able to extract the configurations of 378973 internet-connected devices. Each configuration consisted of the set of open ports, the service running on each of those ports, along with any Common Platform Enumeration (CPE) data that is associated with the particular service.

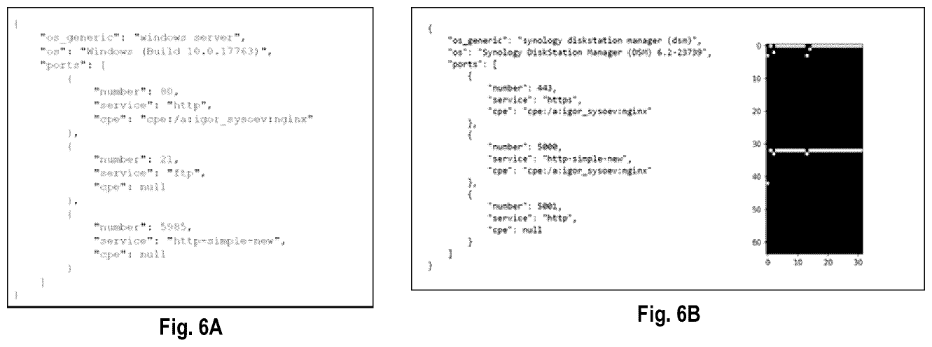

FIG. 6A shows an exemplary JSON document illustrating a device configuration for a Windows Server running three services. FIG. 6B shows an exemplary data model for Machine Configuration. As shown in FIGS. 6A and 6B, on embodiment of each device configuration may be represented as a 64×32 object. The first two columns (which contains 64 rows) encodes the information associated with the operating system and build associated with the particular device. The remaining 30 columns contain information pertaining to the services. Under this model embodiment, and as is being illustrated in FIG. 6B each column will contain exactly two ones. Each of the 30 columns (after the first two) represent a particular port. Each of these 30 columns contains exactly two ones where the one in the first 32 rows indicates the service that is running and the second one present in rows 33-64 indicates the CPE associated with the service.

Uniquely, the device configurations described above and shown in FIGS. 6A and 6B represent the data objects as two-dimensional objects. Accordingly, the plurality of decoy honeypots may be represented as two-dimensional data objects in one embodiment. While two-dimensional objects are typically applied for images, one may realize an advantage for representing device configurations as two-dimensional objects because it enables a GAN architecture comprising two-dimensional convolutions and fractionally strided convolutions. There are many advantages for applying two-dimensional convolutions, such as capturing spatial relationships, translation equivariance, parameter sharing, hierarchical feature learning, local receptive fields, efficiency, and integration with downsampling and upsampling. Specific advantages of fractionally strided convolutions include learnable up sampling, smooth gradient flow, and preservations of spatial hierarchy.

### Evaluation

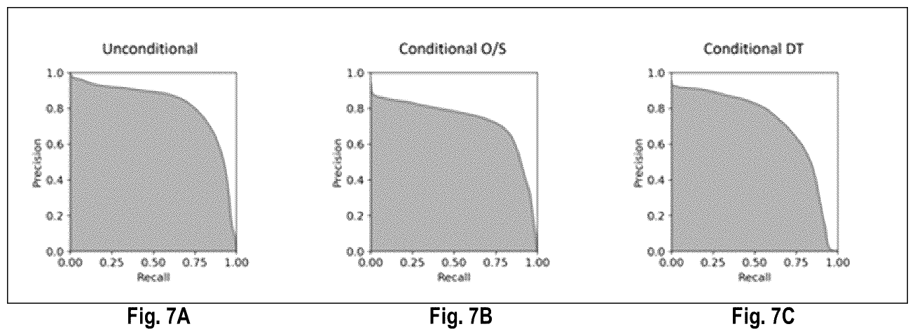

FIG. 7A shows a graph of a recall metric versus a precision metric (PRD plots) for an exemplary unconditionally trained GAN for decoy honeypots. FIG. 7B shows a graph of a recall metric versus a precision metric for an exemplary conditionally trained GAN for decoy honeypots, wherein the conditional training comprises specifying an operating system. FIG. 7C shows a graph of a recall metric versus a precision metric for an exemplary conditionally trained GAN for decoy honeypots, wherein the conditional training comprises specifying a device type.

In order to evaluate the performance of a GAN, one may leverage the notion of precision and recall. Conceptually, a precision metric measures how accurately the generated samples are to the true reference distribution whereas a recall metric attempts to capture how well the true sample distribution is “covered” by the generated distribution. More precisely, suppose that PR represents a reference distribution and PG represents the generated (or learned) distribution. Then for α, β ∈ [0, 1], we say that the probability distribution PG has precision α and recall β with respect to PR if there exists distributions μ, v_{P}_{_{R}}, V_{P}_{_{G}} if

$${P}_{R} = β μ + ( 1 - β ) {v}_{{P}_{R}}$$

$${P}_{G} = α μ + ( 1 - α ) {v}_{{P}_{G}}$$

As can be seen from the expressions above, the parameter 1−β is the recall loss whereas 1−α is the loss due to precision. The set of attainable pairs of precision and recall of a distribution PG with respect to P_{R} consists of all (α, β) pairs that are achievable.

FIG. 7A, 7B, and 7C illustrate the exemplary PRD plots for the three embodiments of GANs that were developed, which we refer to as our unconditional GAN, conditional O/S GAN, and conditional Device Type (DT) GAN. The left plot of FIG. 7A, 7B, and 7C displays the (α, β) pairs for our unconditional (unlabeled) GAN. In this embodiment, the unconditional GAN was trained for 11844 steps after which time the performance of the GAN did not improve. In general, and as can be seen in FIG. 7A, this GAN typically exhibited the highest achievable (α, β) pairs. As a concrete example, if we fix the level of recall to be 0.75, we see that a precision of a >0.8 is possible.

The unconditional GAN provides high levels of precision and recall. In this embodiment, a human cyber defender has no control over the types of samples that it outputs. In order to further advance this approach, we investigated the performance of two additional embodiments of conditional GANs:
Conditional O/S GAN: This model was trained using labels that reflected the operating system.
Conditional Device Type (DT) GAN: This model was trained using labels reflecting the function or type of the underlying device.

These exemplary conditional GAN models are illustrative of this disclosures ability to orient the GAN towards a specific feature. However, the device and O/S conditional models are not exclusive. For example, a GAN model may be conditional based a network feature or network environment.

For a conditional O/S GAN embodiment, each device was assigned exactly one of the following labels reflecting its O/S: Mikrotik Routeros, Windows Server, Windows, Synology Diskstation Manager, Sonicwall Sonico, Linux, Ubuntu, Debian, Synology Router Manager, or QTS. The exemplary distribution comprises a two-dimensional data representation uniquely associates columns 2, 3, . . . , 31 to represent the following ports:
21, 22, 23, 25, 53, 80, 110, 123, 135, 137, 139, 161, 443, 445, 1433, 1701, 1723, 2000, 3306, 3389, 4433, 5000, 5001, 5985, 8080, 8081, 8291, 8443, 8728, 9100.

These ports represent the most frequently occurring open ports that were found across the set of 378973 Shodan device configurations that were used to train the models described in Section 3.On average, this data representation captured over 85% of the services running on each device.

For the conditional device type GAN embodiment, each device was assigned one or more of the following labels: file sharing, remote access, webserver, mailserver, database, dns, vpn, router, and management. The procedure that was followed in assigning devices to labels under the DT GAN architecture is described in more detail, below. The performance of our conditional GANs were evaluated similarly by computing the respective PRD plots. Recall that the conditional DT GAN was trained for 23688 steps whereas the conditional O/S GAN was trained for 5922 steps.2

As can be seen from FIG. 7A, 7B, and 7C, although the conditional GANs afford a cyber-defender greater control over the output configuration (or samples), the penalty for such control are lower levels of achievable (α, β) pairs for the exemplary embodiments utilizes for testing. For example, the conditional O/S GAN never achieves a precision above 0.80 when the recall is above 0.55 and similarly the conditional DT GAN does not achieve a precision above 0.75 when the recall is held at 0.75. Interestingly, the conditional DT had higher values of precision when the recall was allowed to be smaller, but the conditional O/S exhibited larger levels of precision for larger recall values.

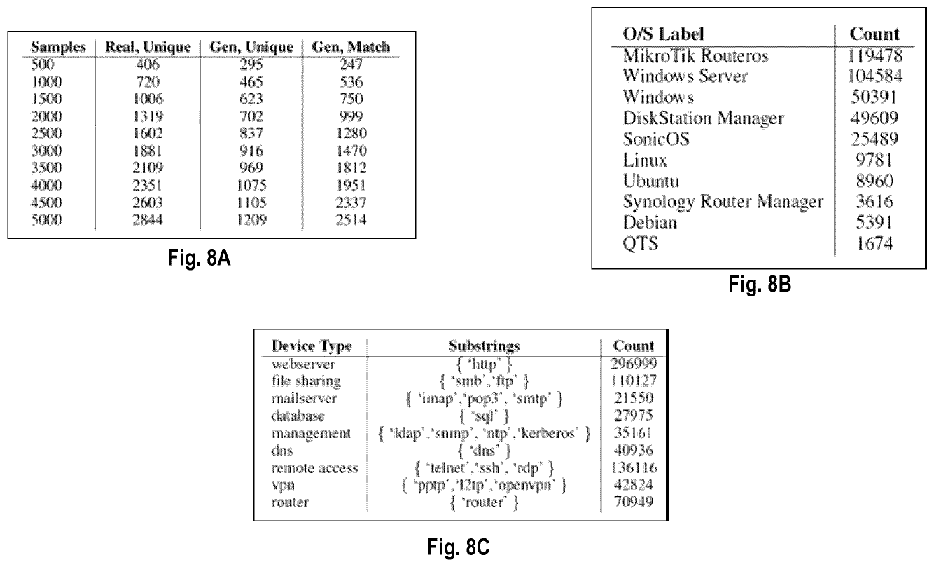

In order to better understand the performance of our test embodiments of a GAN architecture when provided a smaller number of generated samples, we considered the quality of an embodiment of unconditional GAN as a function of the number of outputs. FIG. 8A shows a table comprising exemplary generator output as a function of sample size for an unconditional GAN. In particular, FIG. 8A shows the number of distinct port/service/OS combinations that are generated from our GAN as a function of the number of samples requested. This example shows one embodiment of this technique for illustrative purposes, but is not so limited. For these outputs, we sampled with replacement from the set of real configurations that were retrieved from Shodan as well as a set of configurations that were generated by our unconditional GAN. For example, the first row of the table is showing that among 500 randomly selected real configurations, there were 406 whose port/service/OS information was unique. Then, after our generator produced an equivalent 500 samples, there were 295 unique samples and 247 matched a real configuration. As the generator could generate a given sample multiple times, some of the matches may be repeats of the same configuration, which is why in many cases there are a larger number of matches than unique configurations and is likely a result of over-fitting. As expected, as the number samples increases, the diversity of outputs from our GAN also decreases. Similar exemplary trends were observed with respect to the other two GANs and this data is included in Appendix C.

In addition to considering how the samples generated from each of our three GANs compared to the real set, we also leveraged HoneyD, as a test example, to generate actual low-interaction decoys using port/service/OS data from our unconditional GAN. Using these decoys, we then evaluated the quality of the resulting decoys using the Checkpot honeypot checker utility, which was developed for the purposes of helping security researchers check that their honeypots are properly set up in such a manner as to attract “high-quality traffic.” Towards this end, the Checkpot utility works by taking the network address of a honeypot as input and then outputting a number, known as a Karma value, which indicates the quality of the honeypot specified as input. We created 5000 low-interaction honey-pots with HoneyD using 5000 randomly generated configurations from our unconditional GAN. The average Karma value for the resulting collection of honeypots was 491.584. As a baseline, we also evaluated the Karma value of another publicly available low-interaction honeypot, which according to Checkpot, had a Karma value of only 60.In comparison, we generated HoneyD decoys using 5000 randomly selected real device configurations and found the average Karma value to be 504.91, indicating that the quality of honeypots is nearly the same as if we had stored hundreds of thousands of actual machine configurations.

FIG. 8B shows a table comprising an operating system and label count, for this embodiment, displaying the number of configurations in our dataset for each of the 9 possible types of operating systems. FIG. 8C shows a table comprising device types, substrings, and counts. In order to allow a user to specify the type(s) of device generated by our conditional DT GAN, one or more labels may be assigned to each of the device configurations used during the training process. The logic behind this assignment is illustrated in FIG. 8C. For each device, a label may be applied in the first column if the exemplary Shodan data set contained at least one of the substrings contained in the second column. For example, if the module string returned by Shodan for a particular device contains the substring ‘http,’ then according to our procedure the device would be a webserver. Note that under this procedure, a device may be assigned multiple device type labels so that it is possible that a device is both a webserver and a file sharing server if, for instance, the device is running both an http service and an ftp service. The number of each device type is also represented in the third column.

A System, Apparatus, and Method to Generate Decoy Configurations of Honeypots for Cybersecurity Defenders that are difficult for attackers to detect by using generated adversarial networks can generate high-quality replicas of actual network device configurations using precision and recall metrics. Additionally, two embodiments of conditional GANs may generate network device configurations based on either operating system or service type. The resulting decoys produced by these generative models were then demonstrated to be resilient against current honeypot detection systems.

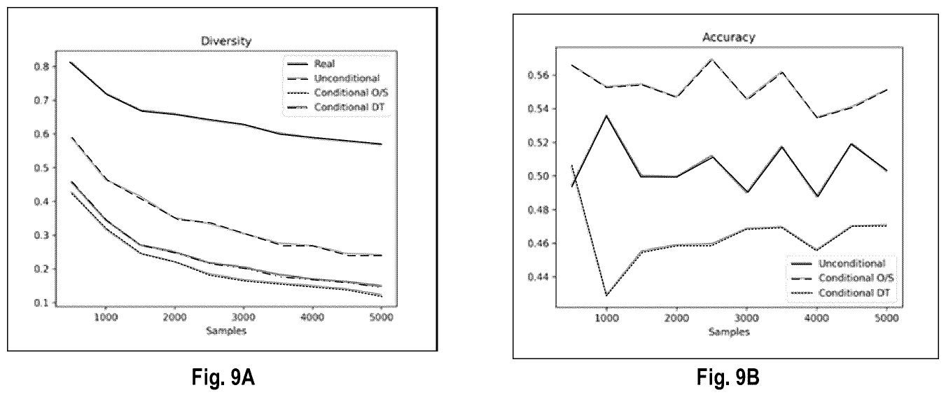

FIG. 9A shows showing the fraction of unique samples that were generated by one embodiment of each of GAN as a function of the number of total samples requested. Note that the data from FIG. 8A is represented as the top two lines of our graph. For instance, FIG. 8A is indicating that given 1000 samples (x-axis) generated from our unconditional GAN the fraction of unique samples is 465/1000 which is displayed as the second line from the top in FIG. 9A.

FIG. 9B shows the fraction of generated samples that match real samples. Information pertaining to the accuracy of each of the three GANs is show in FIG. 9B, displayed in an analogous manner to FIG. 9A.

### Conclusion

The above description of a System, Apparatus, and Method to Generate Decoy Honeypots by Using Generated Adversarial Networks, it is manifest that various techniques may be used for implementing the concepts of A System, Apparatus, and Method to Generate Decoy Honeypots by Using Generated Adversarial Networks without departing from the scope of the claims. The described embodiments are to be considered in all respects as illustrative and not restrictive. The apparatus/system/method disclosed herein may be practiced in the absence of any element that is not specifically claimed and/or disclosed herein. It should also be understood that a System, Apparatus, and Method to Generate Decoy Honeypots by Using Generated Adversarial Networks are not limited to the particular embodiments described herein, but is capable of many embodiments without departing from the scope of the claims.

What is claimed is:

1. A method for generating decoy honeypots, the steps comprising:
identifying a plurality of network device configurations on a network;
instantiating a generative adversarial network comprising architecture properties;
generating a plurality of decoy honeypots with the generative adversarial network, wherein the plurality of decoy honeypots imitate the plurality of network device configurations to deceive malicious actors, and wherein the generative adversarial network optimizes a distribution of the plurality of decoy honeypots according to a precision distribution and a recall distribution;
activating the plurality of decoy honeypots to the network; and
dynamically evolving the plurality of decoy honeypots towards one or more preferences of a network attacker.

2. The method for generating cybersecurity decoys of claim 1, the generative adversarial network further comprising:
using a trained neural network to determine a precision metric of the plurality of network device configurations; and
using a trained neural network to determine a recall metric of the plurality of network device configurations.

3. The method for generating cybersecurity decoys of claim 1, wherein the plurality of decoy honeypots are represented as two-dimensional data objects.

4. The method for generating cybersecurity decoys of claim 3, wherein the generative adversarial network further comprises:
at least one discriminator model using fractionally strided convolutions, and at least one generator model comprising at least four blocks, each block further comprising an upsampling layer and a convolution layer.

5. The method for generating cybersecurity decoys of claim 1, wherein the architecture properties comprise batch size, number of steps, gradient penalty coefficient, and Adam Optimizer parameters.

6. The method for generating decoys of claim 1, wherein the generative adversarial network is unconditionally trained.

7. The method for generating decoys of claim 1, wherein the generative adversarial network is conditionally trained based on operating system type.

8. The method for generating decoys of claim 1, wherein the generative adversarial network is conditionally trained based on device type.

9. A non-transitory computer-readable storage medium comprising computer readable instructions for generating decoy honeypots by using generative adversarial networks, the instructions performing operations comprising:
identifying a plurality of network device configurations on a network;
instantiating a generative adversarial network comprising architecture properties;
generating a plurality of decoy honeypots with the generative adversarial network, wherein the plurality of decoy honeypots imitate the plurality of network device configurations to deceive malicious actors, and wherein the generative adversarial network optimizes a distribution of the plurality of decoy honeypots according to a precision metric and a recall metric;
activating the plurality of decoy honeypots to the network; and
dynamically evolving the plurality of decoy honeypots towards one or more preferences of a network attacker.

10. The non-transitory computer-readable storage medium comprising computer readable instructions for generating decoy honeypots by using generative adversarial networks of claim 9, the generative adversarial network further comprising:
using a trained neural network to determine a precision metric of the plurality of network device configurations;
using a trained neural network to determine a recall metric of the plurality of network device configurations.

11. The non-transitory computer-readable storage medium comprising computer readable instructions for generating decoy honeypots by using generative adversarial networks of claim 9, wherein the plurality of decoy honeypots are represented as two-dimensional data objects.

12. The non-transitory computer-readable storage medium comprising computer readable instructions for generating decoy honeypots by using generative adversarial networks of claim 11, wherein the generative adversarial network further comprises:
at least one discriminator model using fractionally strided convolutions, and
at least one generator model comprising at least four blocks, each block further comprising an upsampling layer and a convolution layer.

13. The non-transitory computer-readable storage medium comprising computer readable instructions for generating decoy honeypots by using generative adversarial networks of claim 9, wherein the architecture properties comprise batch size, number of steps, gradient penalty coefficient, and Adam Optimizer parameters.

14. The non-transitory computer-readable storage medium comprising computer readable instructions for generating decoy honeypots by using generative adversarial networks of claim 9, wherein the generative adversarial network is unconditionally trained.

15. The non-transitory computer-readable storage medium comprising computer readable instructions for generating decoy honeypots by using generative adversarial networks of claim 9, wherein the computer readable instructions are storable without configurations.

16. A network decoy server, comprising:
a network interface communicatively coupled to a network;
at least one processor coupled to the network interface; and
at least one memory coupled to the at least one processor, the at least one memory have instructions stored there, which when executed by the at least one process, direct the network decoy server to:
identifying a plurality of network device configurations on a network;
instantiating a generative adversarial network comprising architecture properties,
generating a plurality of decoy honeypots with the generative adversarial network, wherein the plurality of decoy honeypots imitate the plurality of network device configurations to deceive malicious actors, and wherein the generative adversarial network optimizes a distribution of the plurality of decoy honeypots according to a precision metric and a recall metric, activating the plurality of decoy honeypots to the network, and
dynamically evolving the plurality of decoy honeypots towards one or more preferences of a network attacker.

17. The network decoy server of claim 16, the generative adversarial network further comprising:
using a trained neural network to determine a precision metric of the plurality of network device configurations;
using a trained neural network to determine a recall metric of the plurality of network device configurations.

18. The network decoy server of claim 16, wherein the generative adversarial network further comprises:
at least one discriminator model using fractionally strided convolutions, and
at least one generator model comprising at least four blocks, each block further comprising an upsampling layer and a convolution layer.

19. The network decoy server of claim 16, wherein the architecture properties comprise batch size, number of steps, gradient penalty coefficient, and Adam Optimizer parameters.

20. The network decoy server of claim 16, wherein the generative adversarial network is unconditionally trained.
